(19) United States
(12) Patent Application Publication
(10) Pub. No.: US 2026/0346587 A1
(43) Pub. Date: Nov. 5, 2026

(54) PAPER PACKAGING WITH PRINTED LIGHT-BLOCKING LAYERS

(71) Applicant: AMCOR FLEXIBLES NORTH AMERICA, INC., Neenah, WI (US)

(72) Inventor: Kaisa P. PUTKISTO, Lempäälä (FI)

(21) Appl. No.: 19/488,531

(22) PCT Filed: Jun. 13, 2023
(86) PCT No.: PCT/US2023/025209

§ 371 Date: Nov. 26, 2025

(51) Int. Cl. B32B 27/10; B32B 7/12; B32B 27/08; B32B 27/20; B32B 27/28; B32B 27/30; B32B 27/34; B32B 27/36; B32B 27/40

(52) U.S. Cl. CPC B32B 27/10; B32B 7/12; B32B 27/08; B32B 27/20; B32B 27/285; B32B 27/302; B32B 27/306; B32B 27/308; B32B 27/34; B32B 27/36; B32B 27/40; B32B 2264/1021; B32B 2264/1022; B32B 2264/1023; B32B 2264/104; B32B 2264/1052; B32B 2307/41; B32B 2307/516; B32B 2307/518; B32B 2307/718; B32B 2307/726; B32B 2307/7376; B32B 2439/70

(57) ABSTRACT

A paper-based packaging film includes a paper component, a polymeric film, a first blocking layer comprising metallic flakes and a first coalescent polymer, and a second blocking layer comprising a white pigment and a second coalescent polymer. The first blocking layer is located between the second blocking layer and the paper component and the second blocking layer is located between the first blocking layer and the polymeric film. The first blocking layer comprises about 25% to about 50%, by weight, of the metallic flakes, and a total composition of the paper-based packaging film comprises greater than or equal to 80%, by weight, of the paper component. The paper-based packaging film has a total light transmittance of less than about 5% at a wavelength in a range of from 200 nm to 800 nm.

### TECHNICAL FIELD

This disclosure is related to paper-based packaging film structures. The structures described herein include a printed light-blocking layer.

### BACKGROUND

The goal of increasing recyclability of paper-based packaging films becomes challenging when attempting to form packaging films having improved barrier properties against light penetration. For light-sensitive packaged products, insufficient protection against light penetration may lead to visual and organoleptic defects, loss of nutritional quality, and therefore their shortened shelf-life. Traditionally, improved barrier properties are achieved in paper-based packaging films by forming multilayer films containing a plurality of layers specific to forming the barrier layers and other layers providing enhanced barrier properties. Specific to existing implementations of improving light-blocking properties of paper-based packaging films, the multilayer films may include, for example, laminates of aluminum film (e.g., aluminum foil) and paper, which are further laminated and protected by polyolefin layers. As performance demands increase, the number of layers and/or thickness of one or more layers in the multilayer film may increase, working against the recyclability of the structure as the paper content decreases on a percentage basis and/or the recovery of high-quality fiber (from recycled paper, for example) becomes insufficient.

Paper-based packaging films (or wrapping materials) for food products, such as dairy products including butter, soft cheese, and margarine, are generally available without any specific light-blocking layer (or light barrier, light-blocking thin film, etc.), but may incorporate laminates of aluminum film (or aluminum foil) and paper, which are further laminated and protected by polyolefin layers, to extend shelf-life of the products. A light-blocking layer may reduce or prevent direct photo-oxidation of fat (e.g., lipids) caused by exposure to light typically in the near-UV and blue-light regions, i.e., having wavelength in a range of from 320 nm to 500 nm, as well as oxidation in reactions with photosensitizers such as riboflavin contained in the products. Protection in the full UV and visible (UV-Vis) light regions, i.e., having wavelengths in a range of from 200 nm to 800 nm, may enable efficient blocking of light-induced reactions. Such reactions may cause off-flavors and discoloration in the products. Riboflavin generally has peak absorptions at various wavelengths ranging from 200 nm to 500 nm, and is especially sensitive to wavelengths in a range of from 415 nm to 455 nm. Specific reaction activity may depend on the conditions such as the oxygen concentration, pH, temperature, moisture content, prior light exposure, buffers, catalysts, antioxidants, etc.

A polymeric thin film laminated (or layered) with paper forming a paper-based laminate may be selected to reduce moisture and oxygen permeability of the packaging film designed for food products. The mechanical properties of the polymeric thin film need to support the wrapping functionality of the paper-based laminate including, for example, alignment with the dead-foldability, resistance against tear and puncture, and expectation of limited curl. The laminate may be directed towards (or placed in contact with) the products and the laminate may be expected to have both a paper appearance and ability to be sorted as paper for recycling. However, laminates of a metallized film (e.g., a vacuum-deposited thin film of aluminum) and paper have been observed to provide limited shelf-life, likely due to a combined effect of insufficient barrier against moisture and light. In addition, such metallized laminates may present a metallic shine on an interior surface of the paper (i.e., the surface in contact with the products) and visually interfere with graphics printed on an exterior of the paper, which may be translucent. Furthermore, the metallized laminates may have limited recyclability due to the development of metallic particles in shredding or repulping, where such metallic particles may contaminate the pulp recovered during the recycling process. Accordingly, improvement in light-blocking properties, recyclability, and paper appearance of paper-based packaging film designed for food products may be desired.

### SUMMARY

The present disclosure is related to food packaging, specifically to packaging wrap for dairy products, and more specifically to packaging wrap for butter, soft cheese, and margarine. Disclosed herein are flexible and foldable packaging films having barrier properties against photo-oxidation, as well as moisture and gas permeation, while maintaining recyclability in a paper recycling process. The packaging films include a paper component and at least a printed layer of metallic flakes on a polymeric film, where amounts of non-paper based materials are kept at a minimum to achieve adequate recyclability, among other benefits.

Disclosed herein are paper-based packaging films having a paper component, a polymeric film, a first blocking layer comprising metallic flakes and a first coalescent polymer, and a second blocking layer comprising a white pigment and a second coalescent polymer. The first blocking layer is located between the second blocking layer and the paper component, the second blocking layer is located between the first blocking layer and the polymeric film, the first blocking layer comprises about 25% to about 50%, by weight, of the metallic flakes, and the paper-based packaging film has a water vapor transmission rate of less than or equal to about 15 g/m²/d when tested according to ASTM E 96-80 at 38 °C and 90% RH.

In some embodiments where the white pigment is a first white pigment, paper-based packaging film further comprises a third blocking layer located between the first blocking layer and the paper component. The third blocking layer comprises a second white pigment and a third coalescent polymer. In some embodiments, the first blocking layer is attached to the paper component by an adhesive layer. In some embodiments, the metallic flakes comprise aluminum.

In some embodiments, the paper-based packaging film has a total light transmittance of less than about 5% at a wavelength in a range of from 200 nm to 800 nm. In some embodiments, the paper-based packaging film comprises greater than or equal to about 80%, by weight, of the paper component.

In some embodiments, the first coalescent polymer and the second coalescent polymer each comprise one or more of nitrocellulose, polyurethane, polyamide, polyester, polyether, rosin polymer, ethylene-vinyl acetate, vinyl acetate-ethylene, acrylic, styrene butylene, styrene acrylate, copolymers thereof, and derivatives thereof.

In some embodiments, the first blocking layer and the second blocking layer each have a basis weight in a range of from about 0.5 g/m² to about 5 g/m², from about 0.7 g/m² to about 3 g/m², or from about 1 g/m² to about 2 g/m².

In some embodiments, the white pigment comprises one or more of titanium dioxide, aluminum oxide, silicon dioxide, aluminum silicate, calcium silicate, calcium carbonate, magnesium carbonate, talc, kaolin, zinc oxide, and barium sulfate.

Some embodiments of the paper-based packaging film can be described as having an exterior surface and an interior surface, a paper component, a polymeric film, a printed layer of silver ink on the polymeric film, and a printed layer of white ink on the polymeric film. The exterior surface comprises the paper component and the interior surface comprises the polymeric film. The printed layer of silver ink is located between the polymeric film and the paper component, the printed layer of white ink is located between the printed layer of silver ink and the polymeric film, and the silver ink comprises aluminum flakes.

In some embodiments, the polymeric film comprises one of a monoaxially oriented polyethylene (MDOPE), a monoaxially oriented polypropylene (MDOPP), a biaxially oriented polyethylene (BOPE), a biaxially oriented polypropylene (BOPP), a biaxially oriented polylactic acid (BOPLA), or a biaxially oriented polyester (BOPET).

In some embodiments, the polymeric film has a thickness in a range of from about 2 μm to about 10 μm. In some embodiments, the paper component has a basis weight in a range of from about 35 g/m² to about 80 g/m².

In some embodiments, the paper component has a water absorptiveness in a range of from about 20 g/m² to about 40 g/m² when tested according to TAPPI T 441. In some embodiments, the paper component has a grease resistance in a range of from 10 to 12 when tested according to TAPPI T 559. In some embodiments, a food wrap comprising the paper-based packaging film according to the disclosure is provided.

Some embodiments of the paper-based packaging film can be described as having a paper component, a polymeric film, and a first blocking layer comprising metallic flakes and a first coalescent polymer. The first blocking layer is located between the paper component and the polymeric film, the first blocking layer comprises about 25% to about 50%, by weight, of the metallic flakes, the paper-based packaging film comprises greater than or equal to 80%, by weight, of the paper component, and the paper-based packaging film has a total light transmittance of less than about 5% at a wavelength in a range of from 200 nm to 800 nm.

In some embodiments, the first coalescent polymer comprises one or more of nitrocellulose, polyurethane, polyamide, polyester, polyether, rosin polymer, ethylene-vinyl acetate, vinyl acetate-ethylene, acrylic, styrene butylene, styrene acrylate, copolymers thereof, and derivatives thereof. In some embodiments, the metallic flakes comprise aluminum.

In some embodiments, the paper-based packaging film further comprises a second blocking layer located between the first blocking layer and the polymeric film, the second blocking layer comprising a white pigment and a second coalescent polymer.

### BRIEF DESCRIPTION OF THE DRAWINGS

The disclosure may be more completely understood in consideration of the following detailed description of various embodiments of the disclosure in connection with the accompanying drawings, in which:

FIG. 1 is an embodiment of a cross-sectional view of a paper-based packaging film,

FIG. 2 is another embodiment of a cross-sectional view of a paper-based packaging film,

FIG. 3 is yet another embodiment of a cross-sectional view of a paper-based packaging film,

FIG. 4 is an embodiment of a plan view of an interior surface of an embodiment of a paper-based packaging film,

FIG. 5 is a UV-Vis transmission spectrum (% T) of Inventive Example 1,

FIG. 6 is a UV-Vis transmission spectrum (% T) of Inventive Example 2,

FIG. 7 is a UV-Vis transmission spectrum (% T) of Comparative Example 1,

FIG. 8 is a UV-Vis transmission spectrum (% T) of Comparative Example 2, and

FIG. 9 is a UV-Vis transmission spectrum (% T) of Comparative Example 3.

The Figures are not necessarily to scale. Like numbers used in the Figures refer to like components. It will be understood, however, that the use of a number to refer to a component in each figure is not intended to limit the component in another figure labeled with the same number.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Provided herein are paper-based packaging films that overcome the shortcomings of previously provided films. The paper-based packaging films of the present disclosure are designed to deliver a combination of 1) barrier against photo-oxidation caused by light in the UV/Vis spectrum, 2) barrier against moisture and oxygen permeation, 3) recyclability with high paper content and fiber recovery with reduced or minimal contaminants, 4) appearance of paper despite inclusion of metallic flakes, 5) mechanical resistance to folding, and 6) resistance to freeze-thaw cycles as a result of moisture-resistant paper and adhesive (e.g., repulpable dispersion adhesive, such as vinyl acetate ethylene (VAE)-based adhesive) used the paper-based packaging films.

Improved barrier against photo-oxidation is achieved by embedding a light-blocking layer that includes printed sub-layers of micronic (e.g., particle size on the order of microns) metallic (e.g., aluminum) flakes and white pigment between a paper component and a polymeric film. Adequate recyclability of the paper-based packaging films is improved by at least adjusting the basis weight (or grammage) of the metallic flakes, thereby maintaining a high paper content. Using a suitable adhesive to couple the light-blocking layer with the paper component, the light-blocking layer (i.e., the printed sub-layers of micronic metallic flakes and white pigment on the polymeric film) is separable from the paper component during a repulping process to reduce or minimize pulp contamination by pigment particles and/or metallic particles. The inclusion of one or two printed layers of white pigment adjacent to the printed layer of metallic flakes enhances the paper appearance of the paper-based packaging films, thereby reinforcing their perception as recyclable paper for disposal. In addition, the printed layer of metallic flakes may be applied in a patterned configuration or in a grammage-adjusted fashion to allow optimized barrier against photo-oxidation with a minimum total grammage of the metallic flakes.

The paper-based packaging films described herein include a paper component, a polymeric film, a light-blocking layer printed on the polymeric film, and an adhesive layer coupling the light-blocking layer to the paper component. The light-blocking layer includes a printed layer of metallic flakes as a first sub-layer, optionally a first printed layer of white pigment adjacent to one surface of the printed layer of metallic flakes as a second sub-layer and a second printed layer of white pigment adjacent to an opposite surface of the printed layer of metallic flakes as a third sub-layer. The paper-based packaging films may include additional layers. The combination of these layers can be described as a multilayer film (e.g., a structure or a laminate).

The term “layer”, as used herein, refers to a building block of a film. A layer is a structure of a single material type or a homogeneous blend of materials and may include multiple sub-layers. A layer may include a single polymer, a blend of materials within a single polymer type or a blend of various polymers. A layer may include metallic materials and additives. Layers may be continuous with the film or may be discontinuous or patterned. Both layers and films have a relatively insignificant thickness (z-direction) as compared to their respective length and width (x-y direction).

All layers and films described herein have two major surfaces opposite each other and defined by the x-y plane. A film has an exterior surface that becomes the exterior of a package in which the film is used. When formed into a package, the exterior surface of the film is exposed to the environment. A film has an interior surface that becomes the interior of a package in which the film is used.

As used herein, the term “adjacent” means that the items, such as layers of a film, are near each other, with or without intervening material, such as adhesive. As used herein, the term “directly adjacent” or “in direct contact with” means that the items are in contact with each other, without intervening material.

As used herein, the term “basis weight” is used to refer to the amount of material by weight present in a predetermined area of a film or layer. Typically, the area defined is a square meter, but any area can be used. The area is defined in the length-width (i.e., x-y direction) of the film or layer. A material or a layer of a given thickness (z-direction) and density, has a specific weight when covering a defined area (i.e., a square meter). Basis weight is a commonly used measurement of weight for paper because the density of paper can vary widely. Stated differently, measuring paper by thickness can be difficult. Materials that are applied in discontinuous layers, such as the patterned sealable material, can be defined by basis weight. In the case of patterns, the basis weight refers to the amount of material by weight that is present when covering a defined area. The use of basis weight to measure weight of materials such as paper and patterned materials is common in the film converting industry. Because basis weight can be expressed as grams per unit area (e.g., m²), the term “basis weight” and the term “grammage” are used interchangeably in the present disclosure.

The term “recycling” or “recycling process” generally refers to the reprocessing of waste paper in a production process into new paper and board. The term “recyclability” of paper-based packaging generally relates to the individual suitability of a paper-based packaging for its factual reprocessing in the post-use phase into new paper and board, where “factual” means that separate collection (where relevant) are sorted into grades according to EN 643 (“European list of standard grades of paper and board for recycling”), and final recycling takes place on an industrial scale. Standard paper recycling mills typically have equipment and processes for producing high quality end-products based on EN643 groups 1 to 4 with a classic low consistency pulper (5% fiber concentration). Often, such processes rely on deflakers to separate fiber bundles into individual fibers, as well as coarse and fine screening cleaners. The aim is to separate the fiber from the other material(s). The final result is fibrous material suspended in water ready for papermaking (in other words, recycled pulp). Specialized recycling mills can treat a mix of special grades (group 5 of EN 643) and grades from other groups (1-4 from EN 643). The recovered paper stock preparation process for the packaging stream typically does not include a deinking step for the removal of printing inks. As opposed to a standard recycling mill, a specialized recycling mill determines the optimal mix and adds one or more piece of dedicated equipment, such as a horizontal high density drum pulper, a separate batch pulper with longer pulping time, deinking, fine cleaners, hot dispersion, special process and waste water systems. As in standard mills, the final result of the process is also fibrous material suspended in water ready for papermaking.

As used herein, the terms “standard paper recycling process” and “standard paper mill” are intended to refer to a waste-paper recycling process that is based on one, and typically more, of all common steps selected from repulping, screening, flotation, roughing, concentration, defibrinating, deinking, washing, purification, and bleaching, as is known in the art. Standard paper mills are based on machinery that can accommodate one or more or all of these common steps. In the context of the present invention, the term “standard” means that no additional process steps, machinery, or measures beyond those common steps must be added to the recycling process or mill.

The paper-based packaging films described herein as well as packages prepared therefrom are suitable for recycling in a standard recycling paper process (i.e., they can be processed in a standard paper mill). For the purposes of the present disclosure, recyclability (i.e., the suitability of a paper-based packaging film or package obtained therefrom to be processed in a standard paper recycling process) can be established using standard laboratory testing simulating the industrial standard waste paper process on a laboratory scale, based on characteristics including repulpability and sheet formation. The testing procedure comprises a disintegrating step (pulping step) which is typically performed using a standard disintegrator (according to ISO 5263-1). Testing procedures may comprise one or more of the following phases: disintegration, filtrate analysis, determination of the coarse reject (for example, 5 mm-hole residue), determination of the consistency after the coarse screening (AC), sheet adhesion test and visual appearance test of the accept of the coarse screening, determination of the fine reject (for example, 150 μm slot residue), sheet adhesion test and visual appearance test of the accept of the fine screening, and determination of the content of adhesive particles (macro stickies). The testing procedure may optionally include a sheet forming step (total stock), which may include sheet adhesion testing and a visual appearance test, both typically optional. Specific testing may include one or more the following: measurement of coarse rejects, measurement of the fibrous flake content (fine reject, according to TAPPI T275 sp18), calculation of the content of soluble and colloidal solids below 10 microns (measured according to ISO 4119), measurement of the area of adhesive particle (macro stickies, according to ISO 15360-2, optionally), and indication of the ash content (measured according to ISO 1762, optionally). Standard testing protocols suitable to establish recyclability of a paper-based packaging film or package made therefrom in a standard paper recycling process include one or more of PTS-RH 021-Cat 2, Aticelca 501, and the CEPI “Harmonized European laboratory test method to produce parameters enabling the assessment of the recyclability of paper and board products in standard paper and board recycling mills-Version 2”. For the purposes of the present disclosure, recyclability of the paper-based packaging film or a product made therefrom means that the film or product complies with at least one, two, or all of these standards.

The criteria used in the assessment of the recyclability PTS-RH 021-Cat 2 are repulpability (mass percentage of the constituents not usable in papermaking) and undisturbed sheet formation (purity of the furnish mass percentage usable in papermaking regarding stickies or optical inhomogeneities).

The Aticelca 501:2019 system, which is an evaluation based on laboratory analysis and developed by Aticelca, became the UNI 11743:2019. The analysis simulates the main phases of the industrial process of manufacturing paper to be recycled up in a standard recycling process to producing a new sheet of paper. The technical standard Aticelca 501-19 reproduces at laboratory scale what happens at industrial scale when a paper mill recycles the paper for recycling. Pulping, fiber cleaning, and sheet formation are performed. The following parameters are measured: coarse rejects, fibrous flake content, macrostickies area, sheet formation and adhesiveness, optical inhomogeneities, and ash content, which is optional. The result of the laboratory tests, which analyze the main elements that characterize the recyclability of paper and cardboard and of the products obtained with them, is summarized by an index scaled in four levels of recyclability: A+, A, B, C (and not recyclable), A+ being the highest recyclability level. The CEPI Recyclability Test Method—Version 2 describes a laboratory scale method for determining the key parameters for evaluating the level of recyclability of paper and board-based materials and other cellulose fiber-based products, emulating the relevant phases of standard paper and board recycling mills without deinking technology or other special features to recycle paper for producing new paper and board. This method enables analysis of both process parameters (coarse reject, fine reject, dissolved and colloidal substances and sticky particles with a diameter smaller than 2 mm) and quality parameters (sheet formation and interfering materials like adhesiveness and visual impurities) of products produced from recycled fibers. This document considers only the minimum characteristics of paper and board products that can be generally recycled. Therefore, it does not take into consideration additional specifications related to valorize the paper and board products using deinking technologies. It also does not include parameters of recyclability in mills with specialized processing technology.

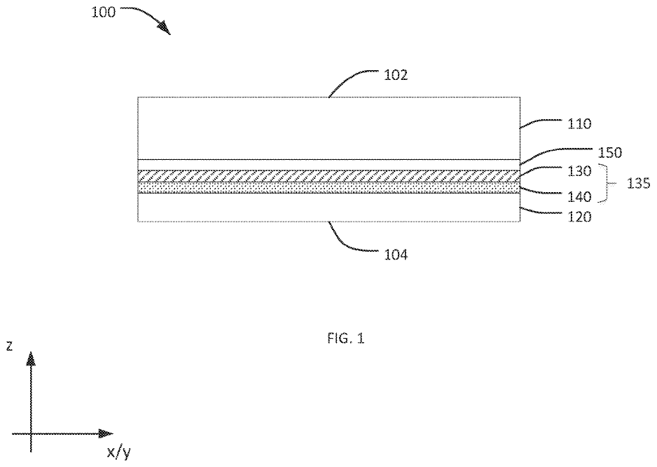

FIG. 1 shows a cross-sectional view (e.g., in the x-z plane or the y-z plane) of an embodiment of a paper-based packaging film 100. In some embodiments, the paper-based packaging film 100 includes a paper component 110 located at an exterior surface 102 of the paper-based packaging film 100, and a polymeric film 120 located at an interior surface 104 of the paper-based packaging film 100. In some embodiments, the paper-based packaging film 100 further includes a first blocking layer 130 adjacent to a second blocking layer 140, which are two sub-layers collectively referred to as a light-blocking layer (or light-barrier layer) 135, between the paper component 110 and the polymeric film 120. In some embodiments, the first blocking layer 130 is located adjacent to the paper component 110 and the second blocking layer 140 is located adjacent to the polymeric film 120. In some embodiments the light-blocking layer 135 is coupled to the paper component 110 by an adhesive layer 150.

In some embodiments, as discussed below, the paper component 110 includes additional components, such as ink and/or lacquer, adjacent to or on the exterior surface 102 of the paper component 110. The paper component 110 may be any type of paper having a basis weight in a range of from about 30 g/m² to about 360 g/m², such as from about 30 g/m² to about 100 g/m², or from about 30 g/m² to about 80 g/m². With reduced or minimized non-paper components, lower paper component weight may be possible while retaining adequate recyclability of the paper-based packaging film 100. The paper component 110 may be coated (e.g., clay-coated) or uncoated.

As described herein, a “total composition” refers to all materials encompassed in a given film. In this regard, the total composition of the paper-based packaging film 100 includes greater than or equal to about 80%, greater than or equal to about 85%, greater than or equal to about 90%, or greater than or equal to about 95%, by weight, of the paper component 110. The total composition of the paper-based packaging film 100 may include less than or equal to about 99%, less than or equal to about 98%, less than or equal to about 97%, or less than or equal to about 96%, by weight, of the paper component 110. For example, the paper-based packaging film 100 may include in a range of about 85% to about 98% of the paper component 110, by weight, of the total composition.

As the paper-based packaging film 100 may be implemented as a food wrap for products such as butter, soft cheese, and margarine, the paper component 110 may be configured with properties including resistance to moisture, resistance to grease, foldability, repulpability, and, in some cases, ability to perform in frozen applications. In some embodiments, a foldable paper component 110 meeting the above criteria may be formed by coating or impregnation techniques.

In some embodiments, a package including the paper-based packaging film 100 as described herein is a fold package formed by fold wrapping the paper-based packaging film 100 around the product to be packaged, for example. The product may be a cuboid product. The fold package may be of any size or shape, such as a cuboid shape of any size. The fold package typically comprises a packaged product.

Fold wrapping typically comprises tightly wrapping the paper-based packaging film 100 around the product to be packaged along fold lines, as is known in the art. A typical folding operation can include a sequence of folding steps so as to create at least two superimposing fold regions (i.e., overlapping parts), which can be superimposed on each other.

For example, a product can be individually wrapped using a sheet of the paper-based packaging film 100 of an appropriate size and shape (for example, a rectangular sheet adapted to the size of the product to be packaged). The product to be wrapped, which may be of a cuboidal shape, for example, is typically placed in the center of the interior surface 104 of the paper-based packaging film 100. The exterior surface 102 of the paper-based packaging film 100 is facing away from the product and towards the environment.

Examples of commonly-used paper component 110 that would be acceptable in the paper-based packaging film 100 described herein include machine-glazed bleached kraft paper (MGBK), glassine, one-side clay-coated paper (C1S), and two-side clay-coated paper (C2S), although less common papers providing improved mechanical or barrier performance by using specialty fibers, fibrillated fibers, or additives could also be used in the paper-based packaging film 100 described herein. Other materials may also be suitable for providing the paper component 110 in accordance with embodiments of the present disclosure.

Additional examples of the paper component 110 that may be useful in the paper-based packaging films 100 include, but are not limited to, kraft paper, parchment, and bleached paper. The paper component 110 may include any type of paper and is preferably selected from paper components that can be processed in a standard paper recycling process. To be suitable, the paper component 110 may be repulpable mechanically and/or chemically, for example. The paper component 110 may be selected based on a repulpability test as described herein for the paper-based packaging film 100.

The paper selected for the paper component 110 may provide grease barrier properties without diminishing its recyclability in a standard paper mill. Specifically, this may be achieved by the use of microfibrillated cellulose-containing paper or paper which has been coated with grease proof coatings. Typical grease-proof coatings used in the industry and also useful herein include polyvinyl alcohol (PVOH), starch, carboxymethyl cellulose (CMC), and alginate-based coating.

For improved barrier against grease, especially when the product to be wrapped with the paper-based packaging film 100 includes butter, soft cheese, or margarine, for example, the paper component 110 is configured with a grease resistance, also known as the Kit Test rating, in a range of from 10 to 12 when tested according to TAPPI T 559. For improved barrier property against moisture, the paper component 110 is configured with a water absorptiveness, also known as the Cobb value, in a range of from about 20 g/m² to about 40 g/m² when tested according to TAPPI T 441.

The paper may be surface treated using one or more types of conventional paper treatments applied on one or both major surfaces of the paper layer. Surface treatments can include physical and/or chemical surface treatments, as is known in the art. Physical treatments include calendering and supercalendering. The paper component 110 may comprise calendered or supercalendered paper. Exemplary chemical surface treatments can comprise applying one or more of agents selected from inorganic surface treatment agents, organic surface treatment agents, and combinations thereof. Exemplary inorganic agents can, for example, be selected from kaolinite, calcium carbonate, bentonite, talc, and chalk or clay, as is well known in the art. Exemplary organic agents can for example be selected from starches, alginates, carboxymethyl celluloses, polyvinyl alcohol, and combinations thereof. The surface treatments can be applied on one or both sides of the paper component 110. Surface treatments can result in coating(s) on one or both sides of the paper component 110. The paper component 110 thus may comprise coating(s) (for example, conventional paper surface coatings used in the manufacture of paper, as is well known in the art of paper making, i.e., not including ink and overlacquer) or may not comprise such coatings.

Suitably, any surface treatments and coatings, if present, are selected that they do not interfere with recyclability in a standard paper recycling process, specifically not with repulpability. Coatings, if present, are preferably selected so that they do not interfere with recyclability in a standard paper recycling process. In some embodiments, the paper component 110 is not mass-treated with components that may interfere with recyclability in a standard paper recycling process. The paper component 110 may not comprise conventional grease resistance coatings and mass treatments based on silicones, PVDC and fluoroalkyls and waxes. The paper component 110, as described herein, does not include non-repulpable paper, or paper that has been mass-treated, for example, with a wet strength treatment. Examples of non-repulpable paper that would not be useful in the paper-based packaging films described herein include, but are not limited to, parchment papers, double-sided wax-treated papers, papers combined with sticky adhesives, and siliconized papers.

In some embodiments, the polymeric film 120 is located at the interior surface 104 and is therefore in direct contact with the product to be wrapped by the paper-based packaging film 100. In some embodiments, the polymeric film 120 includes an oriented film, such as monoaxially oriented polyethylene (MDOPE), monoaxially oriented polypropylene (MDOPP), biaxially oriented polyethylene (BOPE), biaxially oriented polypropylene (BOPP), biaxially oriented polylactic acid (BOPLA), biaxially oriented polyester (BOPET), or combinations thereof. The polymeric film may include a monolayer or multilayers. In some embodiments, the polymeric film 120 may include an unoriented material such as, but not limited to, unoriented PLA. Other oriented or unoriented materials may also be suitable for providing the polymeric film 120 in accordance with embodiments of the present disclosure.

Advantageously, the polymeric film 120 is formed very thin. In some embodiments, the polymeric film 120 has a thickness greater than or equal to about 2 micron (μm), greater than or equal to about 3 μm, or greater than or equal to about 4 μm. The polymeric film 120 may have a thickness less than or equal to about 10 μm, less than or equal to about 9 μm or less than or equal to about 8 μm. For example, the polymeric film 120 may have a thickness in a range of from about 2 μm to about 10 μm, or in a range of from about 2 μm to about 8 μm. In some embodiments, the polymeric film 120 has a thickness in a range of from about 4 μm to about 8 μm.

In some embodiments, the first blocking layer 130 includes at least metallic flakes (or a silver pigment) and a first coalescent polymer, and the second blocking layer 140 includes at least a white pigment and a second coalescent polymer, where the first blocking layer 130 and the second blocking layer 140 are formed (e.g., by printing) between the polymeric film 120 and paper component 110. In this regard, the metallic flakes and the first coalescent polymer (as well as other additives) are from a silver ink (or metallic ink) printed on the polymeric film 120, which is subsequently dried to form the first blocking layer 130. Similarly, the white pigment and the second coalescent polymer are from a white ink printed on the polymeric film 120, which is subsequently dried to form the second blocking layer 140. In some embodiments, the second blocking layer 140 is omitted from the paper-based packaging film 100.

The term “coalescent polymer” may be alternatively referred to as a “binder,” a “binding agent,” a “pigment fixative,” an “adherent,” or the like. In some embodiments, the silver ink and the white ink may each further include a carrier medium (e.g., an organic solvent or water), other pigments, additives, other components, or combinations thereof.

In some embodiments, the first coalescent polymer and the second coalescent polymer each include one or more of nitrocellulose, polyurethane, polyamide, polyesters, polyethers, rosin polymers, and derivatives thereof. In some embodiments, the first coalescent polymer and the second coalescent polymer each include one or more of ethylene-vinyl acetate, vinyl acetate-ethylene, acrylics, styrene butylene, styrene acrylate, polyurethane, copolymers thereof, and derivatives thereof. In some embodiments, the first coalescent polymer and the second coalescent polymer each include a derivative of nitrocellulose. Other polymers may also be suitable for providing the first coalescent polymer and the second coalescent polymer in accordance with embodiments of the present disclosure.

In some embodiments, the metallic flakes include aluminum flakes (or aluminum leaves). In some embodiments, the metallic flakes have an average particle size on the scale of microns. Notably, the metallic flakes of the first blocking layer 130 are delivered in the form of the silver ink, which is applied onto the polymeric film 120 by a suitable printing process, rather than by a vacuum-deposition process (e.g., physical vapor deposition). Examples of the suitable printing process include, but are not limited to, gravure printing, flexo-printing, screen printing, ink-jet, laser printing, and the like.

The metallic flakes may be leafing or non-leafing, which may affect the metallic flakes' wetting properties in the carrier medium during the printing process, as well as the metallic flakes' leveling to form the first blocking layer 130. The present disclosure does not limit the morphology of the metallic flakes. In some examples, the metallic flakes may have smooth and rounded edges, resembling pancakes or silver dollars. In some examples, the metallic flakes may have ragged edges, resembling cornflakes. Examples of commercially available metallic flakes include those made by Eckart, S.P. Morell, and Carlfors. In some embodiments, the total composition of the first blocking layer 130 includes about 25% to about 50%, by weight (based on dry weight), of the metallic flakes.

In some embodiments, the first blocking layer 130 has a basis weight (based on dry weight) in a range of from about 0.5 g/m² to about 5.0 g/m², such as from about 0.7 g/m² to about 3.0 g/m², or from about 1.0 g/m² to about 2.0 g/m². In some examples, the first blocking layer 130 has a basis weight of about 1.6 g/m². In some embodiments, the basis weight of the metallic flakes in the first blocking layer 130 is maintained at a minimum level in order to reduce the cost of production, maintain efficient ink drying during the printing process, and limit the amount of non-paper components in the paper-based packaging film 100 for recycling (or repulping) purposes.

In some examples, a particular morphology of the metallic flakes may cause them to be aligned (e.g., having generally the same orientation) in the first blocking layer 130, resulting in a high reflectivity as well as enhanced hiding power by scattering of light. In some embodiments, the printed layer of the metallic flakes enables reduction in the total light transmittance (TLT) of the paper-based packaging film 100 in the UV/Vis spectrum, such as in a range of wavelength from 200 nm to 800 nm and may be capable of providing optimization of the paper-based packaging film 100 with respect to reducing the total composition of the non-paper components by grammage-adjusted applications, as discussed in detail below. Furthermore, in contrast to the existing packaging films that include laminates of a metallized paper, metallized film with paper, or metal foil (e.g., aluminum foil) with paper, the printed layer of the metallic flakes in the first blocking layer 130 (i.e., after the carrier medium of the silver ink has dried) remains on the polymeric film 120 and is separable from the paper component 110 during the repulping process, thereby reducing contamination of the metallic flakes in the recovered pulp for increased recyclability of the paper-based packaging film 100. In some examples, a low grammage of the metallic flakes in the first blocking layer 130 allows the paper-based packaging film 100 to be recognized as paper in the waste-sorting facilities, thereby improving the recyclability of the paper-based packaging film 100.

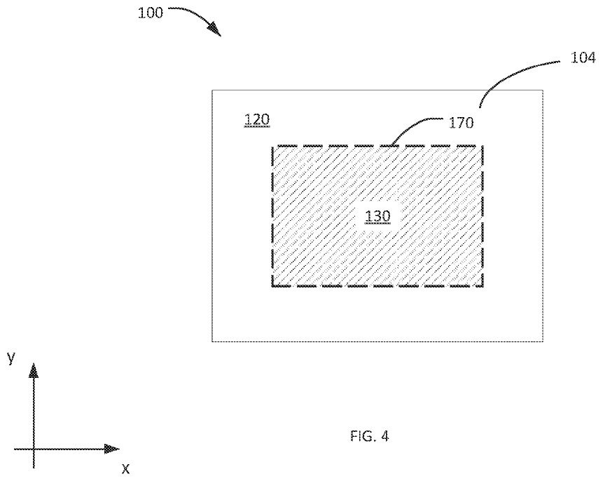

Referring to FIG. 4, which is a top view of the interior surface 104 of the paper-based packaging film 100, the metallic flakes of the first blocking layer 130 may be printed to form a pattern 170 over the polymeric film 120. In some embodiments, an area of the pattern 170 is less than a total area of the paper-based packaging film 100 and corresponds to an area of the paper-based packaging film 100 that is exposed to light while the product is placed on the shelf. In this regard, the overall content of the metallic flakes in the first blocking layer 130 (i.e., the pattern 170) may be adjusted to be less than that of the metallic flakes applied over an entire area of the polymeric film 120.

Advantageously, the ability to pattern and adjust the grammage of the metallic flakes in the first blocking layer 130 provides protection of the product against photo-oxidation without increasing, and in some instances potentially decreasing, the total composition of the non-paper components in the paper-based packaging film 100.

In some embodiments, the white pigment of the second blocking layer 140 includes one or more inorganic materials, such as an oxide, a carbonate, or a sulfate. Examples of the inorganic material include titanium dioxide, aluminum oxide, silicon dioxide, aluminum silicate, calcium silicate, calcium carbonate, magnesium carbonate, talc, kaolin, zinc oxide, and barium sulfate. In an example embodiment, a total composition of the second blocking layer 140 includes about 50% to about 75%, by weight, of titanium oxide, and about 1% to about 10%, by weight, of aluminum oxide. In another example embodiment, a total composition of the second blocking layer 140 includes about 75% to about 95%, by weight, of titanium oxide. Other materials may also be suitable for providing the white pigment in accordance with embodiments of the present disclosure.

In some embodiments, the white pigment in the second blocking layer 140 includes a plurality of fine-sized pigment particles dispersed during the printing process. The pigment particles are configured to scatter light in the UV/Vis spectrum, thereby reducing the amount of light transmitted from the exterior surface 102 toward the interior surface 104 of the paper-based packaging film 100. In this regard, the second blocking layer 140 enhances the barrier property of the light-blocking layer 135, which is also provided by the reflective metallic flakes in the first blocking layer 130. Furthermore, the white pigment in the second blocking layer 140 enhances the paper appearance of the paper-based packaging film 100 when viewed from the interior surface 104, which improves a customer's perception of the paper-based packaging film 100 as a recyclable paper packaging film.

In some embodiments, the paper-based packaging film 100 has a TLT of less than about 5%, such as less than about 3% or less than about 2%, at wavelengths in a range of from 200 nm to 800 nm, which covers light-induced oxidative reactions of lipids as well as the UV/Vis absorptions of their photosensitizers such as riboflavin. Notably, the combination of the silver ink, which includes the metallic flakes, and the white ink, which includes the white pigment, is more effective in providing high optical density at the aforementioned spectral range than a combination of black ink (e.g., non-metallic ink) and white ink at an equal grammage.

As provided herein, the light-blocking layer 135, which includes the first blocking layer 130 and the second blocking layer 140, is embedded between the paper component 110 and the polymeric film 120 within the paper-based packaging film 100. In other words, the light-blocking layer 135 is not exposed at either the exterior surface 102 or the interior surface 104. In this regard, the masking of the light-blocking layer 135 by the paper component 110 limits or removes visual interference of the metallic flakes with graphics printed on the paper component 110 at the exterior surface 102. Furthermore, the masking of the first blocking layer 130 by the second blocking layer 140 as well as the polymeric film 120 also mutes or removes a metallic shine provided by the metallic flakes in the first blocking layer 130. Still further, the embedded light-blocking layer 135 is mechanically resistant to folding without, or substantially without, sustaining fracture or delamination. Accordingly, despite the inclusion of the metallic flakes, such embedded light-blocking layer 135 advantageously enhances the paper appearance (or reducing the metallic appearance) of the paper-based packaging film 100, thereby reinforcing a customer's perception that the paper-based packaging film 100 can be recycled.

As shown, the adhesive layer 150 is disposed in direct contact with a surface of the paper component 110 opposite the exterior surface 102 and adjacent to the first blocking layer 130. In some embodiments, the adhesive layer 150 directly contacts the first blocking layer 130. The adhesive layer 150 may be applied by any known means of web-to-web lamination, such as dry bond lamination, wet bond lamination, or heat lamination. The adhesive layer 150 may have a dry basis weight (e.g., after solvent or carrier removal) in a range of from about 0.5 g/m² to about 4.0 g/m².

The adhesive layer 150 includes an adhesive that is water sensitive. As used herein, the term “water sensitive” means that upon prolonged exposure to or immersion in liquid water, the adhesive loses its adhesive and/or cohesive properties, thus enabling the delamination (i.e., separation) of the paper component from the rest of the paper-based packaging film structure during a repulping process. In some embodiments, the adhesive layer 150 is resistant to moisture, which improves the paper-based packaging film's resistance to freeze-thaw cycles. Water-sensitivity of the adhesive layer 150 can be established using a standard laboratory pulp disintegrator using water at a temperature of about 40°+/−5 °C and 30.000 rotations. In some embodiments, a suitable adhesive does not interfere with recycling in a standard paper recycling process, as determined according to the recyclability standards described herein.

Examples of water-sensitive adhesive include, but are not limited to, latex/casein blends, starch, sugar derivatives, cellulose, amino resin, (poly) acrylate, PVOH, polyvinyl acetate, VAE copolymers, vinyl acetate-ethylene copolymers, polyacrylic acid, maleic acid-modified ethylene copolymers, methylcellulose, carboxy-methylcellulose, carboxy-functional polyesters, polyethylene succinate, polybutylene succinate, ionomers or hydrophilic polyurethane.

In some embodiments, the adhesive layer 150 includes a solvent-free adhesive. In some embodiments, the adhesive layer 150 includes a repulpable water-borne dispersion adhesive. Other materials may also be suitable for providing the adhesive layer 150 in accordance with embodiments of the present disclosure.

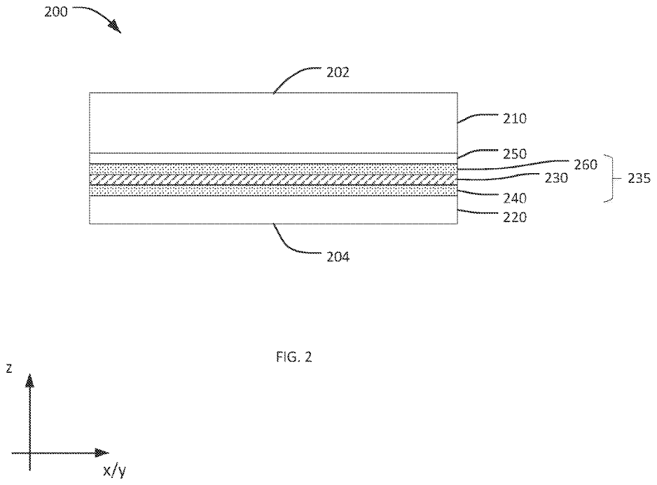

FIG. 2 shows a cross-sectional view (e.g., in the x-z plane or the y-z plane) of an embodiment of a paper-based packaging film 200, which is similar, though not identical, to the paper-based packaging film 100. In some embodiments, the paper-based packaging film 200 includes a paper component 210, which is similar to the paper component 110, that is located at an exterior surface 202 of the paper-based packaging film 200, and a polymeric film 220, which is similar to the polymeric film 120, that is located at an interior surface 204 of the paper-based packaging film 200.

In some embodiments, the paper-based packaging film 200 further includes a first blocking layer 230 located between a second blocking layer 240 and a third blocking layer 260, which are three sub-layers collectively referred to as a light-blocking layer (or light-barrier layer) 235. The first blocking layer 230 and the second blocking layer 240 are similar to the first blocking layer 130 and the second blocking layer 140, respectively. In some embodiments, the third blocking layer 260 is similar to the second blocking layer 240 in composition, although the present disclosure is not limited thereto. For example, the third blocking layer 260 may include a white pigment and a coalescent polymer, where the white pigment and the coalescent polymer have been discussed in detail above with respect to the second blocking layer 140.

In some embodiments, the light-blocking layer 235 is located between the paper component 210 and the polymeric film 220, analogous to the configuration of the light-blocking layer 135 with respect to the paper component 110 and the polymeric film 120. In this regard, the third blocking layer 260 is located between the first blocking layer 230 and the paper component 210 and the second blocking layer 240 is located between the first blocking layer 230 and the polymeric film 220. In some embodiments, the light-blocking layer 235 is coupled to the paper component 210 by an adhesive layer 250, which is similar to the adhesive layer 150.

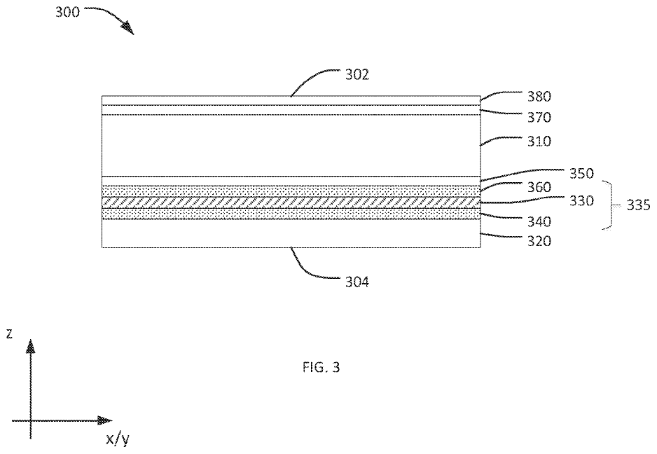

FIG. 3 shows a cross-sectional view (e.g., in the x-z plane or the y-z plane) of an embodiment of a paper-based packaging film 300, which is similar, though not identical, to the paper-based packaging film 100. In some embodiments, the paper-based packaging film 300 includes a paper component 310, which is similar to the paper component 110, that is located at an exterior surface 302 of the paper-based packaging film 300, and a polymeric film 320, which is similar to the polymeric film 120, that is located at an interior surface 304 of the paper-based packaging film 300.

In some embodiments, the paper-based packaging film 300 further includes a first blocking layer 330 located between a second blocking layer 340 and a third blocking layer 360, which are three sub-layers collectively referred to as a light-blocking layer (or light-barrier layer) 335. The first blocking layer 330 and the second blocking layer 340 are similar to the first blocking layer 130 and the second blocking layer 140, respectively. In some embodiments, the third blocking layer 360 is similar to the second blocking layer 340 in composition and may include, for example, a white pigment and a coalescent polymer, where the white pigment and the coalescent polymer have been discussed in detail above with respect to the second blocking layer 140.

In some embodiments, the light-blocking layer 335 is located between the paper component 310 and the polymeric film 320, analogous to the configuration of the light-blocking layer 135 with respect to the paper component 110 and the polymeric film 120. In this regard, the third blocking layer 360 is located between the first blocking layer 330 and the paper component 310 and the second blocking layer 340 is located between the first blocking layer 330 and the polymeric film 320. In some embodiments the light-blocking layer 335 is coupled to the paper component 310 by an adhesive layer 350, which is similar to the adhesive layer 150.

As mentioned previously, the paper-based packaging film 300 may also include a pigment layer (or an ink-based layer) 370 located on the paper component 310 at the exterior surface 102 of the paper-based packaging film 300. The pigment layer 370 may be formed by printing a pigment-containing ink or inks onto the paper component 310. The inks may additionally include a carrier medium (e.g., an organic solvent), additives, other components, or combinations thereof. The inks may be printed to form graphics for describing the product wrapped in the paper-based packaging film 300, for example. In addition, a lacquer 380 may be applied over the pigment layer 370 to provide barrier against moisture and/or other external elements that may compromise the structure of the paper-based packaging film 100. The composition and the grammages of the pigment layer 370 and the lacquer 380 may be varied within ranges agreeable with local paper recycling guidelines.

Embodiments of the present disclosure are now further illustrated with reference to the following Examples.

### EXAMPLES

### Material Selection and Comparison of Physical Properties

Inventive Examples 1 and 2 correspond to embodiments of the paper-based packaging film 100 as depicted in FIG. 1, of the present disclosure. Comparative Examples 1-6 correspond to various examples of paper-based packaging films without the light-blocking layer 135/235/335 described herein. Some of the Comparative Examples, such as Comparative Examples 1 and 2, were applied as foldable food wraps for butter (e.g., butter blocks) for the following tests.

The paper component of Inventive Examples 1 and 2 and Comparative Examples 1, 2, and 4 may be selected from a commercial paper grade, such as Sylvicta and opaque Sylvicta Snow White by Arjowiggins, having a suitable grammage to be laminated with other components of the paper-based packaging film to reach a minimum paper content of about 80% as discussed above. The grammage of the selected paper component (e.g., Sylvicta Snow White) was about 62 g/m². For Comparative Examples 3, 5, and 6, the grammage of the paper component was about 50 g/m². The paper component had an opaque appearance with a light transparency (e.g., according to ISO 2469) of about 57%, which generally does not provide sufficient light-blocking property by itself for achieving an extended shelf-life.

In comparison to Inventive Examples 1 and 2, Comparative Example 1 includes a lacquer, a paper component, an adhesive layer, a metallized (by vacuum-deposition) polymeric film including BOPET, and Comparative Example 2 includes a lacquer, a pigment layer including a white pigment (or white ink), a pigment layer including a black pigment (or black ink), a paper component, an adhesive layer, and a polymeric film including BOPP. In this regard, Comparative Example 2 has full coverage by the pigment layers having the white pigment and the black pigment, each at a grammage of 1.6 g/m², printed on the paper component. The adhesive layer in Comparative Examples 1 and 2 each gave a fiber tear bond or a film tear bond.

With respect to the adhesive layer, a repulpable water-borne dispersion adhesive, such as the VAE-based 5934 by Gludan, was applied as the adhesive layer to the paper component for achieving an elastic bond for Inventive Examples 1 and 2 and Comparative Example 4. In contrast, Comparative Examples 1 and 2 each include a solvent-free adhesive, such as 1KLF196 by Bostik. A bond strength greater than about 3 N/15 mm was reached in the examples tested herein.

When used as foldable food wraps for butter blocks, Comparative Example 2 passed a six-week shelf-life study involving customers. However, the butter blocks wrapped in Comparative Example 1 exhibited topside discoloration. Both laminates of Comparative Examples 1 and 2 were functional in the packaging line (as evaluated, for example, for their surface friction, cutting into sheets and curl of the cut sheets, foldability, stability of the folds, and adherence to the product to produce tight wraps) and for butter freezing tests. Limitations in appearance were recognized with a vacuum-deposited metallized polymeric film of Comparative Example 1 and with the pigments (white and black pigments)-impregnated paper component of Comparative Example 2. Comparative Example 1 appears to have a white-colored paper appearance at the exterior surface but exhibits a metallic shine at the interior surface that is in contact with the butter block. On the other hand, Comparative Example 2 appears to have a dark (or black)-colored paper appearance at both the exterior surface and the interior surface.

When observed through a translucent paper, a metallic surface formed by the metallic flakes printed on the polymeric film of Inventive Example 1, for example, appeared light (or white) in color, while a dark (or black) surface formed by the pigment-impregnated paper component of Comparative Example 2 appeared grey. In this regard, a masking layer printed with white ink (i.e., white pigment), such as the third blocking layer 260 depicted in FIG. 2, is optionally formed between the adhesive layer, such as the adhesive layer 250, and the metallic flakes, such as those of the first blocking layer 230, to improve the paper appearance of the paper-based packaging film.

In manual wrapping tests, the adhesive layer containing 1KLF196 by Bostik was observed to cause some brittleness in the wraps of Comparative Examples 1 and 2. Such brittleness may lead to fracture of the paper component along a folded line and at sharp corners, such as near a pinhole in the vacuum-deposited metallized polymeric film of Comparative Example 1. In this regard, the polymeric film containing BOPP (i.e., Comparative Example 2) appeared more resilient than that containing BOPET (i.e., Comparative Example 1). It is noted that similar fracture and/or pinhole issues were not reported from the customers. In contrast, such brittleness was not observed with the VAE-based Gludan 5934, which is a dispersion adhesive included in Inventive Examples 1 and 2.

### Comparison of Permeabilities

Inventive Example 1 and Comparative Examples 1 and 2 were tested for oxygen transmission rate (OTR) according to ASTM D 3985 at 23 °C/50% RH, and for gravimetric water vapor transmission rate (WVTR) according to ASTM E96-80 at 38 °C/90% RH. The test results, which are shown in Table 1 below, are compared with those of Comparative Example 3, which is a standard sample having a grammage of 96 g/m² and containing a 6.35-μm thick aluminum foil (i.e., a continuous aluminum sheet) laminated with at least a polymeric film and a paper component.

TABLE 1
Permeabilities of Inventive Example 1 in comparison to
Comparative Examples 1, 2, and 3.

| | | OTR | WVTR |
|---|---|---|---|
| | | (cc/m²/ | (g/m²/ |
| Reference | Structure | day) | day) |
| Inventive | Paper (Sylvicta Snow White 62 g/m²)// | <1 | ≤15 |
| Example 1 | Adhesive (VAE-based Gludan 5934)// | | |
| | Metallic flakes HS (total layer 1.6 | | |
| | g/m²)//White pigment (total layer | | |
| | 1.6 g/m²)//BOPP (8 μm) | | |
| Comparative | Lacquer (1 g/m²)//Paper (Sylvicta Snow | <1 | 31-48 |
| Example 1 | White 62 g/m²)//Adhesive (solvent-free | | |
| | Bostik 1KLF 196)//Vacuum-deposition | | |
| | metallized BOPET (4.5 μm) | | |
| Comparative | Lacquer (1 g/m²)//White pigment (total | <1 | 12-16 |
| Example 2 | layer 1.6 g/m²)//Black pigment (total | | |
| | layer 1.6 g/m²)//Paper (Sylvicta Snow | | |
| | White 62 g/m²)//Adhesive (solvent-free | | |
| | Bostik 1KLF 196)//BOPP (8 μm) | | |
| Comparative | Lacquer (1 g/m²)//Pigment//Aluminum | <1 | <0.5 |
| Example 3 | Foil (6.35 μm)//PE extrusion | | |
| | lamination (12 g/m²)//Paper (50 g/m²)// | | |
| | PE extrusion coating (15 g/m²) | | |

### Comparison of Repulpability

Samples of Inventive Example 1 and Comparative Examples 1, 2, and 4 were subjected to a repulpability test, and the results are shown in Table 2 below.

The repulping process, as described further below, removes the paper content from the paper-based packaging film 100 and measures the non-paper content of the paper-based packaging film 100. The recyclability may be assessed by recoverable content or yield, which takes into account all the material that can be recovered to produce new paper. The following procedure was used to determine the yield after a repulping process. The process consists of soaking the starting sample (i.e., the paper-based packaging film 100) in a beaker containing hot water and mixing it to separate the paper from the polymeric film and measure the quantity of recovered paper pulp. In general, the equipment used includes a 5×5 cm cutting template, a graduated beaker capable of holding about 500 ml of water, a heating plate pre-set at about 45 °C, a propeller stirrer with adjustable rotation speed, a thermometer to control the water temperature, a precision scale, and an oven set at about 105 °C to dry the starting samples and the collected reject.

TABLE 2
Evaluation of repulpability of Inventive Example 1 and Comparative Examples
1, 2, and 4. Initial weight before and after drying were measured at 105 °C.

| | | | | | | Fraction |
|---|---|---|---|---|---|---|
| | | Initial | | | | of paper |
| | Initial | weight | Reject | | | lost |
| | weight | after | after | Overall | Weight % | during |
| | before | drying | repulping | yield | paper in | recycling |
| Reference | drying (g) | (g) | (g) | (%) | package | (%) |
| Inventive | 1.586 | 1.469 | 0.28 | 81 | 80 | 0 |
| Example 1 | | | | | (grammage | |
| | | | | | of entire | |
| | | | | | sample: 77 | |
| | | | | | g/m²) | |
| Comparative | 2.154 | 2.042 | 0.21 | 90 | 86 | 0 |
| Example 1 | | | | | (grammage | |
| | | | | | of entire | |
| | | | | | sample: 72 | |
| | | | | | g/m²) | |
| Comparative | 2.244 | 2.134 | 0.46 | 78 | 82 | 3 |
| Example 2 | | | | | (grammage | |
| | | | | | of entire | |
| | | | | | sample: 76 | |
| | | | | | g/m²) | |
| Comparative | 1.595 | 1.477 | 0.29 | 80 | 80 | 0 |
| Example 4 | | | | | (grammage | |
| | | | | | of entire | |
| | | | | | sample: 78 | |
| | | | | | g/m2) | |

Repulpability test results of Inventive Example 1, a structure as described in Table 1, addressed the recovery of high-quality fiber. The printed light-blocking layer was not water sensitive and thus remained attached to the polymeric film. No contamination of the pulp deriving from the printed light-blocking layer was observed. The paper component separated from the polymeric film with no substantial fiber loss due to attachment to the polymeric film (or to the adjacent light-blocking layer). Part of the adhesive layer may have been recovered with the fibers but the adhesive was not observed to cause flocculated fiber (e.g., fibrous flakes) or stickies in the recovered pulp.

With respect to Comparative Example 1, the results of the repulpability test demonstrate that metal particles recovered during the repulping process were due to the detached vacuum deposited metallization of the polymeric film. In this regard, the metal particles were a contaminate to the recovered pulp. With respect to Comparative Example 2, due to the presence of paper flakes visible in the pulp and fibers attached to the polymeric film, a few percentages of the paper component was lost during the recycling test.

The results of the repulpability tests involving Comparative Examples 1 and 2 demonstrate that the vacuum-deposited metallized polymeric film (in Comparative Example 1) and the pigment-impregnated paper component (in Comparative Example 2) may limit the repulpability of the paper component to certain degree as evidenced by the visual presence of impurities such as particles (of Comparative Example 1) and stained pulp (of Comparative Example 2). The adhesive layer detached from the film increased the weighted yield.

Comparative Example 4, which includes a lamination of a paper component (e.g., Sylvicta Snow White with a grammage of 62 g/m²) and a polymeric film (e.g., BOPP with a 12-μm thickness) bonded by a water-borne dispersion adhesive layer (e.g., VAE-based 5934 by Gludan) and having no metal flakes or vacuum-deposited metallization, demonstrated efficient separation of the paper component from the polymeric film when tested in a repulpability test. A detailed description of the structure of Comparative Example 4 may be found in Table 3 below. The paper component separated from the polymeric film with no fibers attached to the polymeric film. Referring to Table 2, the overall yield showed no substantial loss of the paper component during the recycling process, which may be due to part of the adhesive layer being recovered. However, the adhesive did not cause flocculated fiber (e.g., paper flakes) or stickies in the recovered pulp.

Based on the above results, the paper-based packaging film provided in the present disclosure combines metallic flakes printed on a polymeric film for reducing the TLT of the packaging film and a repulpable adhesive for achieving a clean separation during recycling. Notably, the grammage of the metallic flakes printed on the polymeric film is kept at a minimum value to maintain a sufficiently low TLT as well as to reduce the overall non-paper components of the laminate.

### Comparison of Total Light Transmittance (TLT)

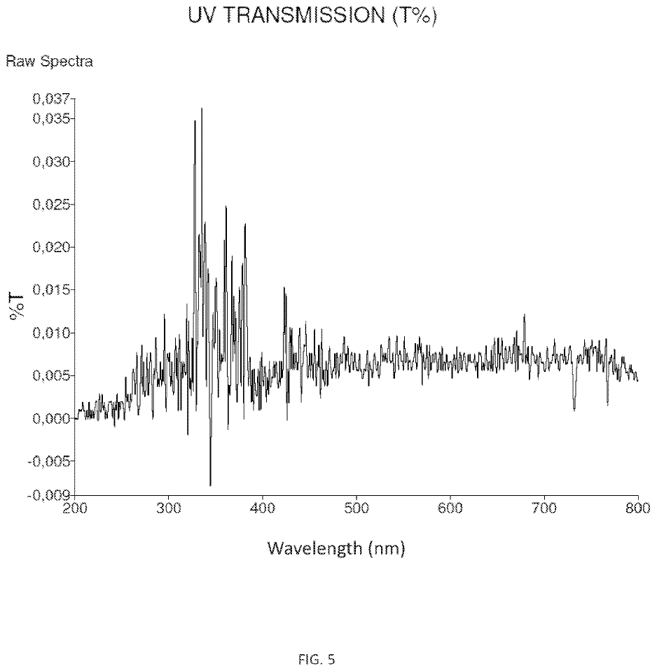

Inventive Examples 1 and 2 and Comparative Examples 1-6 were measured using a PerkinElmer Lambda 25 UV/Vis Spectrophotometer, which was implemented in conjunction with a UV WinLab software, at wavelengths in a range of from 200 nm to 800 nm (i.e., the UV-Vis spectrum). The UV-Vis transmission (labeled as % T) spectra of Inventive Examples 1 and 2 and Comparative Examples 1-3 are illustrated in FIGS. 5-9, respectively.

The TLT (%), which can be considered as a complementary analysis to the UV-Vis transmission spectra, was evaluated using BYK Instruments haze-gard i at wavelengths in a range of from 300 nm to 800 nm, according to ASTM D 1003. The results are shown in Table 3 below.

It is noted that for Inventive Examples 1 and 2, different types of metallic flakes designated as “HS” and “HT,” respectively, were used. However, the resulting values of TLT do not differ significantly between these Examples (e.g., both are less than about 5%). With the exception of Comparative Example 1, which includes vacuum-deposited metallized BOPET, and Comparative Example 3, which includes an aluminum foil, the remaining comparative examples do not include any metal particles laminated with or deposited onto the polymeric film and have each resulted in a TLT that is at least about 5% in the UV-Vis spectrum. This suggests that the metallic flakes printed on the polymeric film is generally effective in reducing the TLT of the paper-based packaging film and improving the barrier properties of the paper-based packaging film against photo-oxidation by light in the UV-Vis spectrum. With respect to Comparative Example 3, the inclusion of aluminum foil and two polymeric layers reduce the paper content of the paper-based packaging film, thereby reducing its recyclability at disposal.

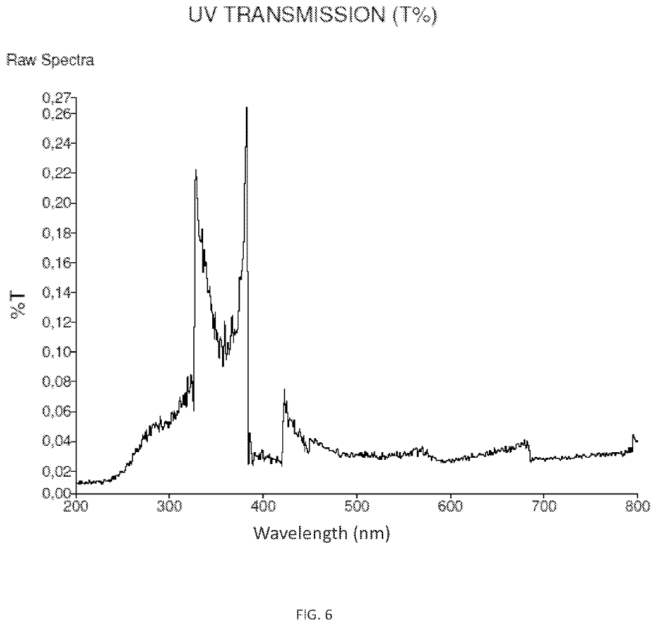

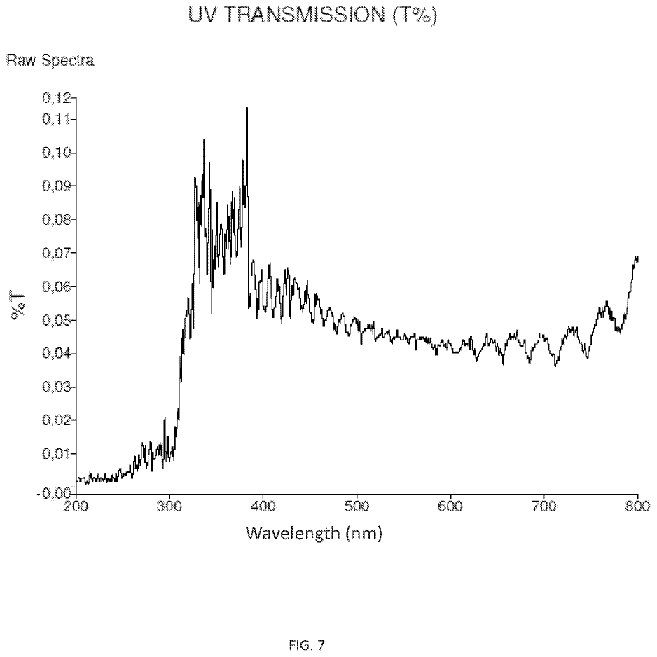

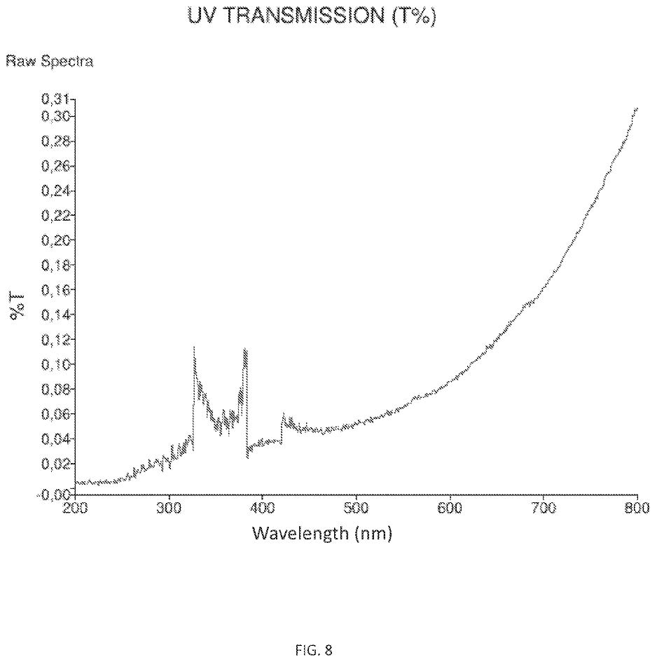

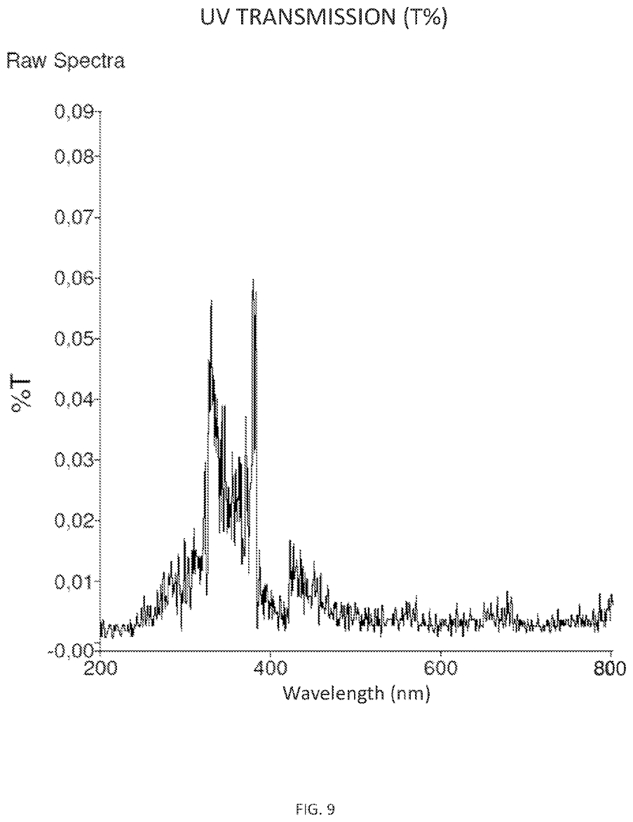

TABLE 3
Comparison of TLT (%) measured at
wavelengths in the UV-Vis spectrum.

| | | TLT |
|---|---|---|
| Reference | Structure | (%) |
| Inventive | Paper (Sylvicta Snow White 62 g/m²)//Adhesive | 1.0 |
| Example 1 | (VAE-based Gludan 5934)//Metallic flakes HS | |
| (FIG. 5) | (total layer 1.6 g/m²)//White pigment (total | |
| | layer 1.6 g/m²)//BOPP (8 μm) | |
| Inventive | Paper (Sylvicta Snow White 62 g/m²)//Adhesive | 3.0 |
| Example 2 | (VAE-based Gludan 5934)//Metallic flakes HT | |
| (FIG. 6) | (total layer 1.6 g/m²)//White pigment (total | |
| | layer 1.6 g/m²)//BOPP (8 μm) | |
| Comparative | Lacquer (1 g/m²)//Paper (Sylvicta Snow White | 2.8 |
| Example 1 | 62 g/m²)//Adhesive (solvent-free Bostik | |
| (FIG. 7) | 1KLF 196)//Vacuum-deposition metallized | |
| | BOPET (4.5 μm) | |
| Comparative | Lacquer (1 g/m²)//White pigment (total layer | 6.0 |
| Example 2 | 1.6 g/m²)//Black pigment (total layer 1.6 | |
| (FIG. 8) | g/m²)//Paper (Sylvicta Snow White 62 | |
| | g/m²)//Adhesive (solvent-free Bostik 1KLF | |
| | 196)//BOPP (8 μm) | |
| Comparative | Lacquer (1 g/m²)//Pigment//Aluminum Foil | 0 |
| Example 3 | (6.35 μm)/PE extrusion lamination (12 | |
| (FIG. 9) | g/m²)//Paper (50 g/m²)//PE extrusion coating | |
| | (15 g/m²) | |
| Comparative | Paper (Sylvicta Snow White 62 g/m²)// | >50 |
| Example 4 | Adhesive (VAE-based Gludan 5934)//BOPP | |
| | (12 μm) | |
| Comparative | White pigment (total layer 1.6 g/m²)//Paper | 17.0 |
| Example 5 | (50 g/m²)//PE extrusion coating (15 g/m²) | |
| Comparative | Metallic flakes (total layer 1.6 g/m²)//White | 5.0 |
| Example 6 | pigment (total layer 1.6 g/m²)//Paper (50 g/m²)// | |
| | PE extrusion coating (15 g/m²) | |

### EMBODIMENTS

Embodiment A: A paper-based packaging film comprising: a paper component, a polymeric film, a first blocking layer comprising metallic flakes and a first coalescent polymer, and a second blocking layer comprising a white pigment and a second coalescent polymer, wherein: the first blocking layer is located between the second blocking layer and the paper component, the second blocking layer is located between the first blocking layer and the polymeric film, a total composition of the first blocking layer comprises about 25% to about 50%, by weight, of the metallic flakes, and the paper-based packaging film has a water vapor transmission rate of less than or equal to about 15 g/m²/d when tested according to ASTM E 96-80 38 °C/90% RH.

Embodiment B: The paper-based packaging film according to Embodiment A, wherein the white pigment is a first white pigment, further comprising a third blocking layer located between the first blocking layer and the paper component, the third blocking layer comprising a second white pigment and a third coalescent polymer.

Embodiment C: The paper-based packaging film according to any of Embodiment A and B, wherein the first blocking layer is attached to the paper component by an adhesive layer.

Embodiment D: The paper-based packaging film according to any of Embodiment A through C, wherein the metallic flakes comprise aluminum.

Embodiment E: The paper-based packaging film according to any of Embodiment A through D, wherein the paper-based packaging film has a total light transmittance of less than about 5% at a wavelength in a range of from 200 nm to 800 nm.

Embodiment F: The paper-based packaging film according to any of Embodiment A through E, wherein a total composition of the paper-based packaging film comprises greater than or equal to about 80%, by weight, of the paper component.

Embodiment G: The paper-based packaging film according to any of Embodiment A through F, wherein the first coalescent polymer and the second coalescent polymer each comprise one or more of nitrocellulose, polyurethane, polyamide, polyester, polyether, rosin polymer, ethylene-vinyl acetate, vinyl acetate-ethylene, acrylic, styrene butylene, styrene acrylate, copolymers thereof, and derivatives thereof.

Embodiment H: The paper-based packaging film according to any of Embodiment A through G, wherein the first blocking layer and the second blocking layer each have a basis weight in a range of from about 0.5 g/m² to about 5 g/m², from about 0.7 g/m² to about 3 g/m², or from about 1 g/m² to about 2 g/m².

Embodiment I: The paper-based packaging film according to any of Embodiment A through H, wherein the white pigment comprises one or more of titanium dioxide, aluminum oxide, silicon dioxide, aluminum silicate, calcium silicate, calcium carbonate, magnesium carbonate, talc, kaolin, zinc oxide, and barium sulfate.

Embodiment J: A paper-based packaging film comprising: an exterior surface and an interior surface, a paper component, a polymeric film, a printed layer of silver ink on the polymeric film, and a printed layer of white ink on the polymeric film, wherein: the exterior surface comprises the paper component, the interior surface comprises the polymeric film, the printed layer of silver ink is located between the polymeric film and the paper component, the printed layer of white ink is located between the printed layer of silver ink and the polymeric film, and the printed layer of silver ink comprises aluminum flakes.

Embodiment K: The paper-based packaging film according to Embodiment J, wherein the polymeric film comprises one or more of monoaxially oriented polyethylene (MDOPE), monoaxially oriented polypropylene (MDOPP), biaxially oriented polyethylene (BOPE), biaxially oriented polypropylene (BOPP), biaxially oriented polylactic acid (BOPLA), and biaxially oriented polyester (BOPET).

Embodiment L: The paper-based packaging film according to any of Embodiment J and K, wherein the polymeric film has a thickness in a range of from about 2 μm to about 10 μm.

Embodiment M: The paper-based packaging film according to any of Embodiment J through L, wherein the paper component has a basis weight in a range of from about 35 g/m² to about 80 g/m².

Embodiment N: The paper-based packaging film according to any of Embodiment J through M, wherein the paper component has a water absorptiveness in a range of from about 20 g/m² to about 40 g/m² when tested according to TAPPI T 441.

Embodiment O: The paper-based packaging film according to any of Embodiment J through N, wherein the paper component has a grease resistance in a range of from 10 to 12 when tested according to TAPPI T 559.

Embodiment P: A food wrap comprising a paper-based packaging film according to any Embodiment A through O.

Embodiment Q: A paper-based packaging film comprising: a paper component, a polymeric film, and a first blocking layer comprising metallic flakes and a first coalescent polymer, wherein: the first blocking layer is located between the paper component and the polymeric film, the first blocking layer comprises about 25% to about 50%, by weight, of the metallic flakes, a total composition of the paper-based packaging film comprises greater than or equal to 80%, by weight, of the paper component, and the paper-based packaging film has a total light transmittance of less than about 5% at a wavelength in a range of from 200 nm to 800 nm.

Embodiment R: The paper-based packaging film according to Embodiment Q, wherein the first coalescent polymer comprises one or more of nitrocellulose, polyurethane, polyamide, polyester, polyether, rosin polymer, ethylene-vinyl acetate, vinyl acetate-ethylene, acrylic, styrene butylene, styrene acrylate, copolymers thereof, and derivatives thereof.

Embodiment S: The paper-based packaging film according to any of Embodiment Q and R, wherein the metallic flakes comprise aluminum.

Embodiment T: The paper-based packaging film according to any of Embodiment Q through S, further comprising a second blocking layer located between the first blocking layer and the polymeric film, the second blocking layer comprising a white pigment and a second coalescent polymer.

What is claimed is:

1. A paper-based packaging film comprising:
a paper component,
a polymeric film,
a first blocking layer comprising metallic flakes and a first coalescent polymer, and
a second blocking layer comprising a white pigment and a second coalescent polymer,
wherein:
the first blocking layer is located between the second blocking layer and the paper component,
the second blocking layer is located between the first blocking layer and the polymeric film,
a total composition of the first blocking layer comprises about 25% to about 50%, by weight, of the metallic flakes, and
the paper-based packaging film has a water vapor transmission rate of less than or equal to about 15 g/m²/d when tested according to ASTM E 96-80 38 °C/90% RH.

2. The paper-based packaging film according to claim 1, wherein the white pigment is a first white pigment, further comprising a third blocking layer located between the first blocking layer and the paper component, the third blocking layer comprising a second white pigment and a third coalescent polymer.

3. The paper-based packaging film according to claim 1, wherein the first blocking layer is attached to the paper component by an adhesive layer.

4. The paper-based packaging film according to claim 1, wherein the metallic flakes comprise aluminum.

5. The paper-based packaging film according to claim 1, wherein the paper-based packaging film has a total light transmittance of less than about 5% at a wavelength in a range of from 200 nm to 800 nm.

6. The paper-based packaging film according to claim 1, wherein a total composition of the paper-based packaging film comprises greater than or equal to about 80%, by weight, of the paper component.

7. The paper-based packaging film according to claim 1, wherein the first coalescent polymer and the second coalescent polymer each comprise one or more of nitrocellulose, polyurethane, polyamide, polyester, polyether, rosin polymer, ethylene-vinyl acetate, vinyl acetate-ethylene, acrylic, styrene butylene, styrene acrylate, copolymers thereof, and derivatives thereof.

8. The paper-based packaging film according to claim 1, wherein the first blocking layer and the second blocking layer each have a basis weight in a range of from about 0.5 g/m² to about 5 g/m², from about 0.7 g/m² to about 3 g/m², or from about 1 g/m² to about 2 g/m².

9. The paper-based packaging film according to claim 1, wherein the white pigment comprises one or more of titanium dioxide, aluminum oxide, silicon dioxide, aluminum silicate, calcium silicate, calcium carbonate, magnesium carbonate, talc, kaolin, zinc oxide, and barium sulfate.

10. A paper-based packaging film comprising:
an exterior surface and an interior surface,
a paper component,
a polymeric film,
a printed layer of silver ink on the polymeric film, and
a printed layer of white ink on the polymeric film,
wherein:
the exterior surface comprises the paper component,
the interior surface comprises the polymeric film,
the printed layer of silver ink is located between the polymeric film and the paper component,
the printed layer of white ink is located between the printed layer of silver ink and the polymeric film, and
the printed layer of silver ink comprises aluminum flakes.

11. The paper-based packaging film according to claim 10, wherein the polymeric film comprises one or more of monoaxially oriented polyethylene (MDOPE), monoaxially oriented polypropylene (MDOPP), biaxially oriented polyethylene (BOPE), biaxially oriented polypropylene (BOPP), biaxially oriented polylactic acid (BOPLA), and biaxially oriented polyester (BOPET).

12. The paper-based packaging film according to claim 10, wherein the polymeric film has a thickness in a range of from about 2 μm to about 10 μm.

13. The paper-based packaging film according to claim 10, wherein the paper component has a basis weight in a range of from about 35 g/m² to about 80 g/m².

14. The paper-based packaging film according to claim 10, wherein the paper component has a water absorptiveness in a range of from about 20 g/m² to about 40 g/m² when tested according to TAPPI T 441.

15. The paper-based packaging film according to claim 10, wherein the paper component has a grease resistance in a range of from 10 to 12 when tested according to TAPPI T 559.

16. A food wrap comprising a paper-based packaging film according to claim 10.

17. A paper-based packaging film comprising:
a paper component,
a polymeric film, and
a first blocking layer comprising metallic flakes and a first coalescent polymer,
wherein:
the first blocking layer is located between the paper component and the polymeric film,
the first blocking layer comprises about 25% to about 50%, by weight, of the metallic flakes,
a total composition of the paper-based packaging film comprises greater than or equal to 80%, by weight, of the paper component, and
the paper-based packaging film has a total light transmittance of less than about 5% at a wavelength in a range of from 200 nm to 800 nm.

18. The paper-based packaging film according to claim 17, wherein the first coalescent polymer comprises one or more of nitrocellulose, polyurethane, polyamide, polyester, polyether, rosin polymer, ethylene-vinyl acetate, vinyl acetate-ethylene, acrylic, styrene butylene, styrene acrylate, copolymers thereof, and derivatives thereof.

19. The paper-based packaging film according to claim 17, wherein the metallic flakes comprise aluminum.

20. The paper-based packaging film according to claim 17, further comprising a second blocking layer located between the first blocking layer and the polymeric film, the second blocking layer comprising a white pigment and a second coalescent polymer.
